(19) United States
(12) Patent Application Publication
(10) Pub. No.: US 2020/0364794 A1
(43) Pub. Date: Nov. 19, 2020

(54) SYSTEMS AND METHODS FOR PROVIDING MULTIPLE OPTION SPREADS ACCRUED INCOME COUPON NOTES

(71) Applicant: JPMORGAN CHASE BANK, N.A., New York, NY (US)

(72) Inventor: Hamilton REINER, Westport, CT (US)

(21) Appl. No.: 15/930,308

(22) Filed: May 12, 2020

Related U.S. Application Data
(60) Provisional application No. 62/847,976, filed on May 15, 2019.

(51) Int. Cl. G06Q 40/06; G06N 20/00

(52) U.S. Cl. CPC G06Q 40/06; G06N 20/00

(57) ABSTRACT

According to another embodiment, in a machine learning and data science engine comprising at least one computer processor, a method for providing multiple option spreads accrued income coupon notes may include: (1) scanning a plurality of data sources for equities and equity derivatives to identify a universe of equities and equity derivatives that are available for including in a Multiple Option Spreads Accrued Income Coupon (MOSAIC) Note; (2) receiving a sought outcome for an investment portfolio including the MOSAIC Note; (3) selecting a variable feature for the MOSAIC Note including at least one of an underlying security, an underlying index, a level of income, a money-ness of options in the MOSAIC Note, a quantity of the options in the MOSAIC Note, a date of option expiry, and a size of the MOSAIC Note relative to the investment portfolio; and (4) optimizing the selected variable feature based on the sought outcome.

### RELATED APPLICATIONS

This application claims the benefit of, and priority to, U.S. Provisional Patent Application Ser. No. 62/847,976, filed May 15, 2019, the disclosure of which is hereby incorporated, by reference, in its entirety.

### BACKGROUND OF THE INVENTION

### 1. Field of the Invention

Embodiment generally relate to systems and methods for providing multiple option spreads accrued income coupon notes.

### 2. Description of the Related Art

When a fund invests in Equity Linked Notes (ELNs), it receives cash in the form of coupon, but may limit some of its opportunity to profit from an increase in the market value of the instrument due to the call options written within the particular ELN.

If the ELN is held to maturity, the issuer will pay the purchaser the underlying instrument's value at maturity with any necessary adjustments. The holder of an ELN that is linked to a particular underlying security or instrument may be entitled to receive dividends paid in connection with that underlying equity security, but typically does not receive voting rights as it would if it directly owned the underlying equity security.

### SUMMARY OF THE INVENTION

Systems and methods for providing multiple option spreads accrued income coupon notes are disclosed. According to one embodiment, in an information processing apparatus comprising at least one computer processor, a method for providing multiple option spreads accrued income coupon notes may include: (1) selecting an investment amount to include in a Multiple Option Spreads Accrued Income Coupon (MOSAIC) Note and an investment amount to make outside of the MOSAIC Note; (2) selecting an investment having a beta profile for the investment amount outside of the MOSAIC Note; (3) generating the MOSAIC Note including one unit of at least an equity and market exposure; (4) determining a short call out of the money-ness based on a goal amount of income and an upside goal for an investment period; (5) determining a number of short multiple calls to include in the MOSAIC note based on the beta profile; (6) determining a number of long multiple calls to include in the MOSAIC Note based on the number of short multiple calls; and (7) determining a level of out of the money-ness of the long calls by dividing 100% of the MOSAIC note by a net exposure above a strike price for the short call.

In one embodiment, the equity and market exposure may include the Standard & Poor's 500 index.

In one embodiment, the having a beta profile for the investment amount outside of the MOSAIC Note may be selected using machine learning.

In one embodiment, the investment amount inside of the MOSAIC note and the investment amount outside of the MOSAIC Note may amount to a complete portfolio value.

In one embodiment, the number of long multiple calls may be the same as the number of short multiple calls.

According to another embodiment, in a machine learning and data science engine comprising at least one computer processor, a method for providing multiple option spreads accrued income coupon notes may include: (1) scanning a plurality of data sources for equities and equity derivatives to identify a universe of equities and equity derivatives that are available for including in a Multiple Option Spreads Accrued Income Coupon (MOSAIC) Note; (2) receiving a sought outcome for an investment portfolio including the MOSAIC Note; (3) selecting a variable feature for the MOSAIC Note including at least one of an underlying security, an underlying index, a level of income, a money-ness of options in the MOSAIC Note, a quantity of the options in the MOSAIC Note, a date of option expiry, and a size of the MOSAIC Note relative to the investment portfolio; and (4) optimizing the selected variable feature based on the sought outcome.

In one embodiment, the sought outcome may include at least one of an income amount, a risk amount, a Sharpe ratio, a Sortino ratio, a volatility, and a total return.

In one embodiment, the sought outcome may be based on a sought outcome for a second portfolio.

According to another embodiment, a system for providing multiple option spreads accrued income coupon notes may include a source of equity information; a source of equity derivative information; a source of portfolio outcome information; and a machine learning and data sciences engine comprising at least one computer processor. The machine learning and data sciences engine may scan the source of equity information and the source of equity derivative information to identify a universe of equities and equity derivatives that are available for including in a Multiple Option Spreads Accrued Income Coupon (MOSAIC) Note, my receive a sought outcome for an investment portfolio including the MOSAIC Note from the source of portfolio outcome information, may receive an investment amount to include in the MOSAIC Note and an investment amount to make outside of the MOSAIC Note; may select an investment in the universe of equities and equity derivatives having a beta profile for the investment amount outside of the MOSAIC Note; may generate the MOSAIC Note including one unit of at least an equity and market exposure from the source of equity or market exposure information; may determine a short call out of the money-ness based on the sought outcome for an investment period; may determine a number of short multiple calls to include in the MOSAIC note based on the beta profile; may determine a number of long multiple calls to include in the MOSAIC Note based on the number of short multiple calls; may determine a level of out of the money-ness of the long calls by dividing 100% of the MOSAIC note may a net exposure above a strike price for the short call; may select a variable feature for the MOSAIC Note including at least one of an underlying security, an underlying index, a level of income, a money-ness of options in the MOSAIC Note, a quantity of the options in the MOSAIC Note, a date of option expiry, and a size of the MOSAIC Note relative to the investment portfolio; and may optimize the selected variable feature based on the sought outcome.

In one embodiment, the equity and market exposure may include the Standard & Poor's 500 index.

In one embodiment, the investment having a beta profile for the investment amount outside of the MOSAIC Note may be selected using machine learning.

In one embodiment, the investment amount inside of the MOSAIC note and the investment amount outside of the MOSAIC Note may amount to a complete portfolio value.

In one embodiment, the number of long multiple calls may be the same as the number of short multiple calls.

In one embodiment, the sought outcome may include at least one of an income amount, a risk amount, a Sharpe ratio, a Sortino ratio, a volatility, and a total return.

In one embodiment, the sought outcome may be based on a sought outcome for a second portfolio.

In one embodiment, the selected variable feature may be optimized using machine learning.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for providing multiple option spreads accrued income coupon notes according to one embodiment;

FIG. 2 depicts a method for providing multiple option spreads accrued income coupon notes according to one embodiment;

FIG. 3 depicts a method for distributions using a MOSIAC Note according to one embodiment;

FIG. 4 illustrates a method of MOSAIC distributions according to one embodiment;

FIG. 5 depicts a system for machine learning-based MOSAIC note generation according to one embodiment; and

FIG. 6 depicts a method for machine learning-based MOSAIC note generation according to one embodiment.

### DETAILED DESCRIPTION OF PREFERRED EMBODIMENTS

Embodiments are directed to Multiple Option Spreads Accrued Income Coupon Notes (MOSAIC Notes).

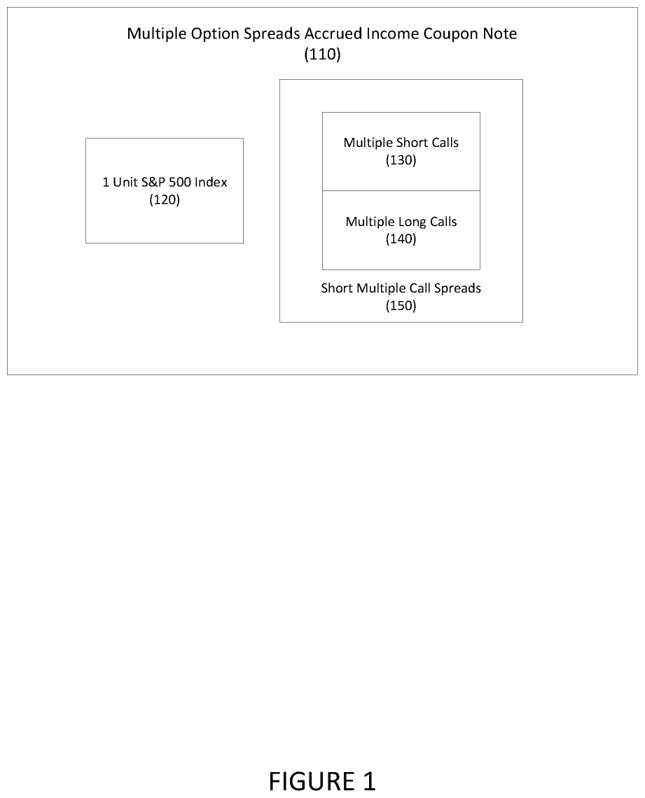

Referring to FIG. 1, a schematic of a Multiple Option Spreads Accrued Income Coupon Note (MOSAIC Note) is provided according to one embodiment. MOSAIC Note 110 may include one unit of an equity and/or market index 120, such as the S&P 500 index, short multiple calls 130, and long multiple calls 140 (which together create the short multiple call spreads 150). The use of the S&P 500 index is exemplary only, and other equities and/or market indices may be used as is necessary and/or desired.

As indicated in FIG. 1, short multiple call spreads 150 consists of short multiple calls 130 and long multiple calls 140, and MOSAIC Note 110 consists of market index 120 and short multiple call spreads 150.

In one embodiment, MOSAIC Note 110 converts an option premium into ordinary income or coupon. It implements call spreads that allow the note to approach a value of 0 but never go negative. It can have a varying number of such call spreads (e.g., 5.5). It includes options designed to provide a consistent stream of income or coupon.

A traditional ELN is structured such that there is one long equity and/or market index unit for one call sold. With MOSAIC Note 110, there is one long equity unit 120 for multiple short calls 130 sold. For example, there is one unit of S&P 500 index and 5.5 short calls sold, so the net exposure is net short 4.5 units.

If the market goes up significantly (e.g., up 25%), a traditional ELN could hypothetically go negative. To ensure that this does not happen, MOSAIC Note 110 includes an equal number of long calls 140 (e.g., also 5.5 calls).

In one embodiment, a calculation to determine the out of the money-ness of the calls bought: 100% of the value of the MOSAIC Note 110 (e.g., 100%) divided by the net exposure (e.g., net short 4.5 units). In this example, 100%/4.5=22.22%. So, the market needs to go up 22.22% for the net short 4.5 call options to make the note approach 0. Thus, 22% out of the money calls are bought to offset the net short 4.5 call options so the note does not go negative.

A portfolio manager, which may be a human and/or an automated process, may invest in MOSAIC Notes looking to optimize the combination of income and upside opportunity. The portfolio manager may use the calculation above to determine what out of the money call to purchase. Depending on the number of call options sold and consequent net exposure, the spread changes (i.e., if one takes 100% of the MOSAIC Note and has 4 net short options, the spread is $25; if one takes 100% of the MOSAIC Note and has 5 net short options, the spread is $20). Based on the net short options' exposure, the portfolio manager purchases an equal amount of call options (the fewer net short call options, the offsetting call options can be bought X % higher).

Advantages may include at least some of the following: (1) a unique multiplier effect: rather than traditional 1:1 ratio of long equity and/or market exposure to calls sold within an ELN, there is a 1:multiple ratio of long equity and/or market exposure to calls sold; (2) an innovative call spread effect: shorting multiple calls and purchasing an equal number of calls such that a MOSAIC Note cannot go negative (calculation: 100% of the MOSAIC Note divided by the net short options' exposure=% out of the money-ness of calls bought); (3) converts option premium into ordinary income/coupon, rather than its traditional treatment as capital gain, permitting distribution of premium directly to the client as bona fide income/coupon; (4) allows portfolio manager to sell options (embedded within the MOSAIC Note) on the rest of a portfolio (i.e., If there is a long portfolio with 85% long equities and/or market exposure and 15% MOSAIC Notes that contain S&P 500 units, the portfolio now has 100% equity and/or market exposure. Then, the multiple short call spreads can be utilized across the entire portfolio). MOSAIC Notes may generate significant income that can be applied across the whole investment strategy; in the above example, the MOSAIC Notes yield ˜25-50% income annualized.

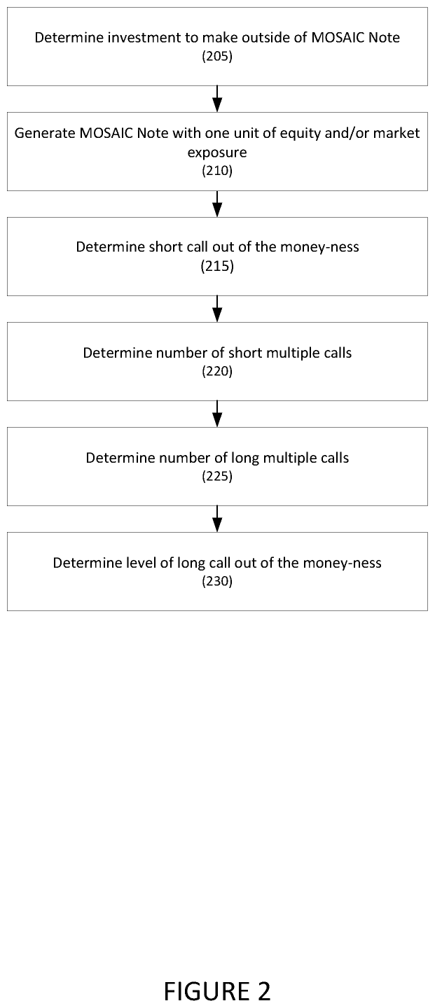

Referring to FIG. 2, in step 205, an investment made outside of the MOSAIC Note is determined (for example, 85% of the equity exposure will be outside of the MOSAIC Note, and 15% of the equity exposure will be inside of the MOSAIC Note, to create 100% of the equity value). This investment outside of the MOSAIC Note may be a fundamental or quantitatively built portfolio, involving factors or machine learning.

In step 205, in one embodiment, machine learning may be used to select one or more outside investments with a certain beta profile.

In step 210, a MOSAIC Note may be generated by including one unit of an equity and/or market exposure, such as the S&P 500 index.

In step 215, a short call out of the money-ness is determined. Determinations may be made, both qualitatively and quantitatively, as to the amount of income and upside desired for the period, and therefore the out of the money-ness of the short calls.

In step 220, the number of short multiple calls to include in the MOSAIC Note may be determined. In one embodiment, the beta profile in step 205 is used to determine the number of short multiple calls.

In step 225, the number of long multiple calls to include in the MOSAIC Note is determined based on the same number of short multiple calls in 220. In one embodiment, the number of long multiple calls may be the same as the number of short multiple calls.

In step 230, the level of out of the money-ness of the long calls, or the difference in levels between the long and short calls, is determined. In one embodiment, the calculation to determine the spread/width of out of the money calls (i.e., the out-of-the-moneyness) is 100% of the MOSAIC Note divided by the net exposure.

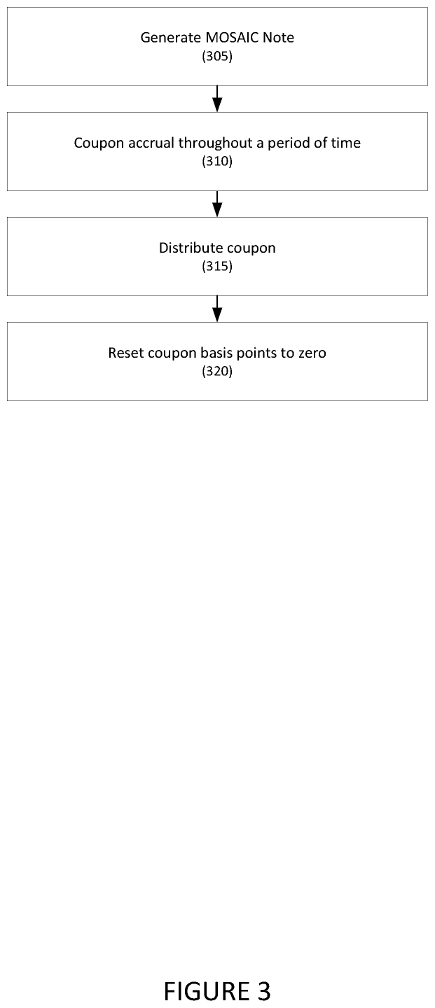

Referring to FIG. 3, a method for distributions using a MOSIAC Note is disclosed according to one embodiment.

In step 305, a MOSAIC note, such as that disclosed above, may be generated.

In step 310, the coupon may accrue throughout a period of time, such as a month.

In step 315, at the end of the period, the coupon may be distributed.

In step 320, after distribution, the coupon basis points may be reset to zero, and the process may be repeated.

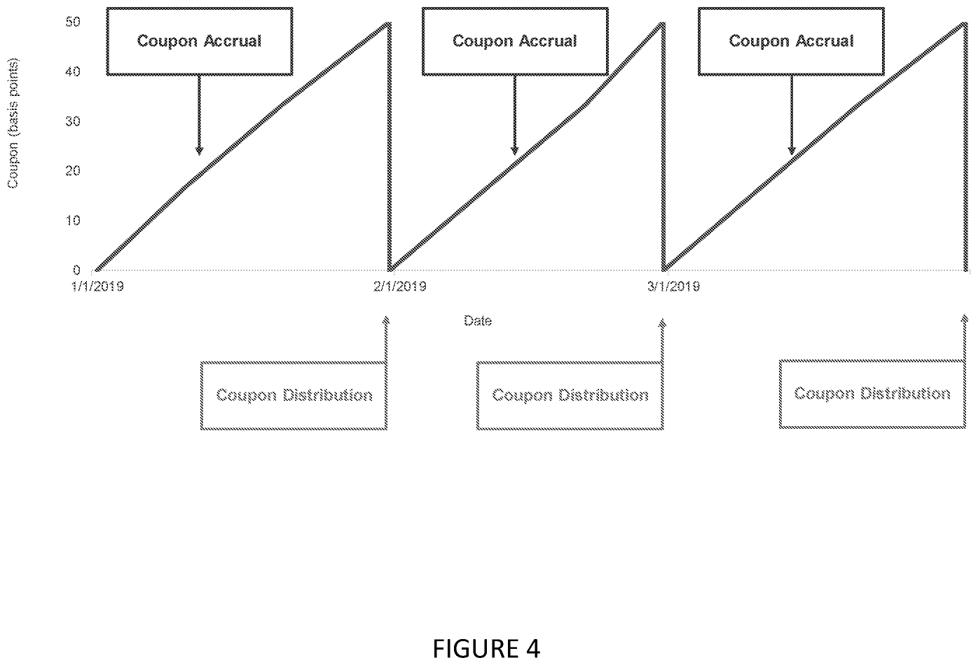

An exemplary illustration is provided in FIG. 4.

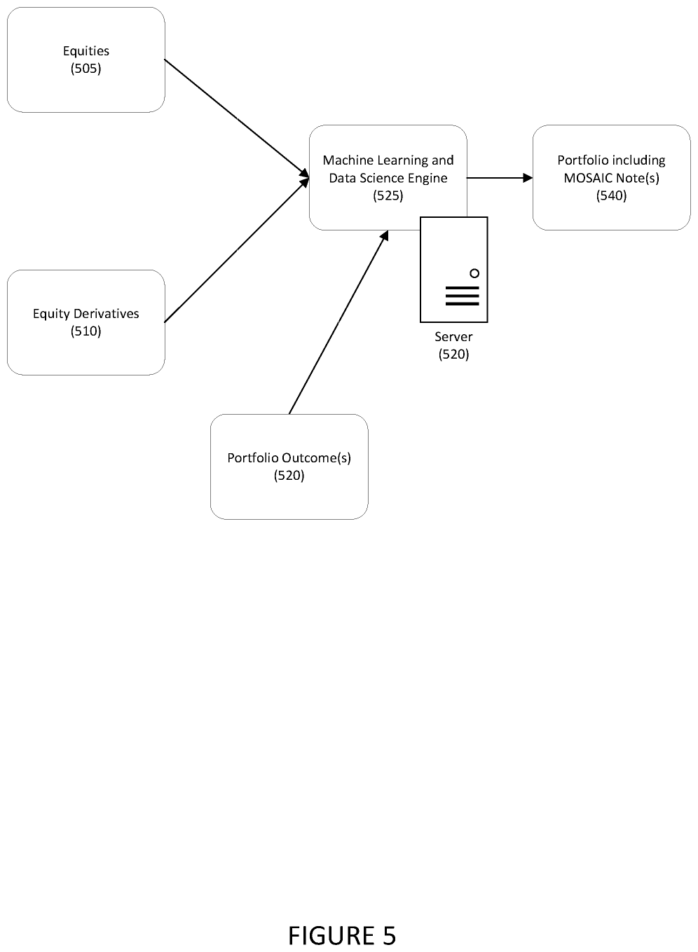

Referring to FIG. 5, a system for machine learning-based MOSAIC note generation is provided according to one embodiment. In embodiment, machine learning and data science engine 535 that may be executed by server 530 may be used to build MOSAIC Notes into an optimized portfolio. Server 530 may be any suitable electronic device, including physical servers, cloud-based servers, combinations thereof, etc.

Machine learning and data science engine 535 may scan equities data source 505 and equity derivatives data source 510 to identify suitable equities and equity derivatives suitable for specific portfolio outcome 520. Examples of portfolio outcomes 520 include, for example, income, risk, Sharpe ratio, volatility, total return, etc.

Machine learning and data science engine 535 may consider the universe of equities and equity derivatives, and the identified outcome orientation, and may determine the composition of the MOSAIC Notes to be used within portfolio 540.

Machine learning and data science engine 535 may reconcile historical security prices, volatility data, and current market conditions in keeping with portfolio outcome 520 in order to create specific MOSAIC Notes using one or more algorithm. These algorithms may select variable features for the MOSAIC Notes, such as the underlying securities/indices, level of income, money-ness of the options, quantity of options/multiples (options spreads also change commensurately with the multiples), date of option expiry, and size of the MOSAIC Notes relative to portfolio 540.

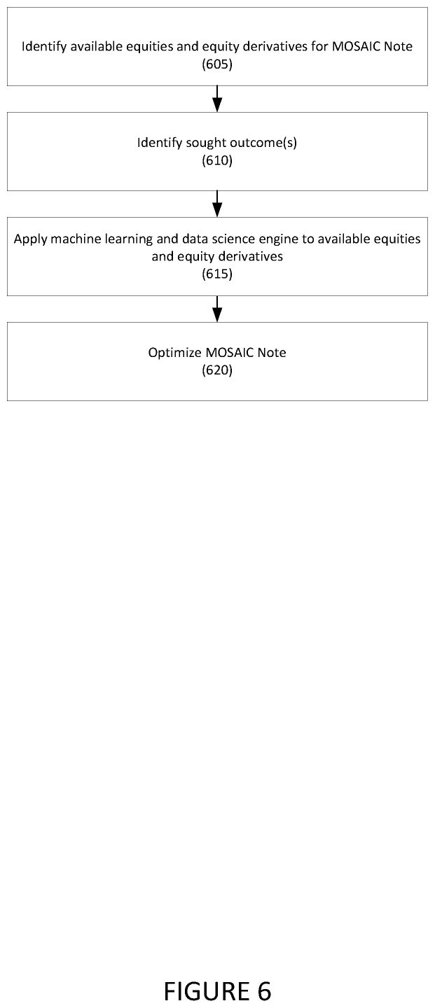

Referring to FIG. 6, a method for machine learning-based MOSAIC Note generation is provided according to one embodiment. In step 605, a machine learning and data science engine may scan data sources for equities and equity derivatives to identify a universe of equities and equity derivatives that are available for one or more MOSAIC Notes as described above.

In step 610, the machine learning and data science engine may receive one or more sought outcomes for the portfolio. In one embodiment, the sought outcome(s) may be received from a user for each portfolio, or they may be related to other portfolios. Examples of portfolio outcomes include, for example, income, risk, Sharpe ratio, volatility, total return, etc.

In step 615, the machine learning and data science engine may identify the equities and/or equity derivatives based on the portfolio outcome(s). For example, in one embodiment, the underlying equity portfolio and associated risk profile based on the portfolio outcome may be identified. Based on that index overlay and its associated beta, the ratio of the options may be determined. Based on the income goal, the delta of the options to target may be identified.

In step 620, the machine learning and data science engine may apply one or more algorithm to optimize the MOSAIC Note. In embodiments, the algorithms may select variable features for the MOSAIC Notes, such as the underlying securities/indices, level of income, money-ness of the options, quantity of options/multiples (options spreads also change commensurately with the multiples), date of option expiry, and size of the MOSAIC Notes relative to portfolio. Determining and building these variable features into the MOSAIC Note helps to construct a fully optimized portfolio (comprising both equity and/or market exposure and MOSAIC Notes) to achieve a desired outcome, such as a targeted income, volatility, Sharpe ratio, Sortino ratio, or return level. One or more of these features may be optimized to achieve the desired outcome, using, for example, artificial intelligence, machine learning, etc.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing multiple option spreads accrued income coupon notes, comprising:
in an information processing apparatus comprising at least one computer processor:
selecting an investment amount to include in a Multiple Option Spreads Accrued Income Coupon (MOSAIC) Note and an investment amount to make outside of the MOSAIC Note;
selecting an investment having a beta profile for the investment amount outside of the MOSAIC Note;
generating the MOSAIC Note including one unit of at least an equity and market exposure;
determining a short call out of the money-ness based on a goal amount of income and an upside goal for an investment period;
determining a number of short multiple calls to include in the MOSAIC note based on the beta profile;
determining a number of long multiple calls to include in the MOSAIC Note based on the number of short multiple calls; and
determining a level of out of the money-ness of the long calls by dividing 100% of the MOSAIC note by a net exposure above a strike price for the short call.

2. The method of claim 1, wherein the equity and market exposure comprises the Standard & Poor's 500 index.

3. The method of claim 1, wherein the investment having a beta profile for the investment amount outside of the MOSAIC Note is selected using machine learning.

4. The method of claim 1, wherein the investment amount inside of the MOSAIC note and the investment amount outside of the MOSAIC Note amounts to a complete portfolio value.

5. The method of claim 1, wherein the number of long multiple calls is the same as the number of short multiple calls.

6. A method for providing multiple option spreads accrued income coupon notes, comprising:
in a machine learning and data science engine comprising at least one computer processor:
scanning a plurality of data sources for equities and equity derivatives to identify a universe of equities and equity derivatives that are available for including in a Multiple Option Spreads Accrued Income Coupon (MOSAIC) Note;
receiving a sought outcome for an investment portfolio including the MOSAIC Note;
selecting a variable feature for the MOSAIC Note including at least one of an underlying security, an underlying index, a level of income, a money-ness of options in the MOSAIC Note, a quantity of the options in the MOSAIC Note, a date of option expiry, and a size of the MOSAIC Note relative to the investment portfolio; and
optimizing the selected variable feature based on the sought outcome.

7. The method of claim 6, wherein the sought outcome comprises at least one of an income amount, a risk amount, a Sharpe ratio, a Sortino ratio, a volatility, and a total return.

8. The method of claim 6, wherein the sought outcome is based on a sought outcome for a second portfolio.

9. A system for providing multiple option spreads accrued income coupon notes, comprising:
a source of equity information;
a source of equity derivative information;
a source of portfolio outcome information; and
a machine learning and data sciences engine comprising at least one computer processor;
wherein:
the machine learning and data sciences engine scans the source of equity information and the source of equity derivative information to identify a universe of equities and equity derivatives that are available for including in a Multiple Option Spreads Accrued Income Coupon (MOSAIC) Note;
the machine learning and data sciences engine receives a sought outcome for an investment portfolio including the MOSAIC Note from the source of portfolio outcome information;
the machine learning and data sciences engine receives an investment amount to include in the MOSAIC Note and an investment amount to make outside of the MOSAIC Note;
the machine learning and data sciences engine selects an investment in the universe of equities and equity derivatives having a beta profile for the investment amount outside of the MOSAIC Note;
the machine learning and data sciences engine generates the MOSAIC Note including one unit of at least an equity and market exposure from the source of equity or market exposure information;
the machine learning and data sciences engine determines a short call out of the money-ness based on the sought outcome for an investment period;
the machine learning and data sciences engine determines a number of short multiple calls to include in the MOSAIC note based on the beta profile;
the machine learning and data sciences engine determines a number of long multiple calls to include in the MOSAIC Note based on the number of short multiple calls;
the machine learning and data sciences engine determines a level of out of the money-ness of the long calls by dividing 100% of the MOSAIC note by a net exposure above a strike price for the short call;
the machine learning and data sciences engine selects a variable feature for the MOSAIC Note including at least one of an underlying security, an underlying index, a level of income, a money-ness of options in the MOSAIC Note, a quantity of the options in the MOSAIC Note, a date of option expiry, and a size of the MOSAIC Note relative to the investment portfolio; and
the machine learning and data sciences engine optimizes the selected variable feature based on the sought outcome.

10. The system of claim 9, wherein the equity and market exposure comprises the Standard & Poor's 500 index.

11. The system of claim 9, wherein the investment having a beta profile for the investment amount outside of the MOSAIC Note is selected using machine learning.

12. The system of claim 9, wherein the investment amount inside of the MOSAIC note and the investment amount outside of the MOSAIC Note amounts a complete portfolio value.

13. The system of claim 9, wherein the number of long multiple calls is the same as the number of short multiple calls.

14. The system of claim 9, wherein the sought outcome comprises at least one of an income amount, a risk amount, a Sharpe ratio, a Sortino ratio, a volatility, and a total return.

15. The system of claim 9, wherein the sought outcome is based on a sought outcome for a second portfolio.

16. The system of claim 9, wherein the selected variable feature is optimized using machine learning.
